(19) United States
(12) Patent Application Publication
(10) Pub. No.: US 2016/0114270 A1
(43) Pub. Date: Apr. 28, 2016

(54) Water Filter with Electrical Conductivity Meter and Pair of Anodes Attached to Internal Filter

(71) Applicants: Erez Mazor, Tveria (IL); Ronen Aharon Cohen, Moza Elit (IL)

(72) Inventors: Erez Mazor, Tveria (IL); Ronen Aharon Cohen, Moza Elit (IL)

(73) Assignee: GENERAL FILTER BENLEUMI LTD, Tveria (IL)

(21) Appl. No.: 14/734,409

(22) Filed: Jun. 9, 2015

(30) Foreign Application Priority Data
Oct. 28, 2014 (IL) 235375

(51) Int. Cl. B01D 35/143; C02F 1/00

(52) U.S. Cl. CPC B01D 35/143; C02F 1/003; C02F 2303/04

(57) ABSTRACT

A water filtration system that comprises a filter housing and an internal filter. The filter housing has an internal chamber that contains an electrical conductivity meter with two contact points. The internal filter has a pair of anodes designed to be in contact with said pair of contact points and, as a result, with the electrical conductivity meter.

### TECHNICAL FIELD

The present invention refers to a water filtration system that comprises a filter housing with a designated chamber for an electrical conductivity meter and an internal filter equipped with a pair of anodes, which enable real-time determination of the contamination status of the internal filter installed in the filter housing.

### BACKGROUND ART

Water filtration is a process in which substances, chemicals and contaminants are removed from water. The most common objective of water filtration is to clean water so as to render it suitable for personal use and drinking. The use of water filters is known and very widespread; water filters are used to purify and treat water, including water designated for drinking. In many places it is customary to install a water filtration system on the water pipe that supplies the kitchen sink or even on the main inlet pipe of the structure, with the objective of cleaning and purifying the water and improving its quality, and thus enabling the public to consume and drink water without fear of contamination. It is also customary to install filters on refrigerators and other household appliances. Unfortunately, the consumer public has no way of knowing for sure whether or not the water filter is indeed functioning efficiently and purifying the water as required; Therefore, a sensor may be installed as part of the filtration system, to check the water quality. The problem with such systems that are equipped with a sensor is that although the sensor checks the water, it does not check the condition of the internal filter itself. The present invention offers a good and effective solution to this problem.

US Patent Application No. 2006/0011523A1 (hereinafter “US Application 523”) describes a water filter cartridge that includes a unit sensor that is equipped with two electrodes. The housing of the water filter cartridge has an opening or a breach in it through which said electrodes can be inserted to be in contact with the purified water exiting from a sieve through which the purified water come through. The sensor unit in US Application 523 is designed to be installed on the filter cartridge through said opening or breach. Part of the electrodes of the unit sensor is then inserted into the water filter cartridge. The invention described in US Application 523 has several disadvantageous. First, when the need arises to replace the water filter cartridge, the user must uninstall the sensor unit and reinstalled it on the new cartridge. The invention, subject of the present application, describes a permanent housing for a replaceable filter cartridge core that includes a special chamber into which a sensor is installed permanently. When the need arises to replace the replaceable filter cartridge core, the user needs not touch the sensor.

Second, US Application 523 refers to a replaceable water filter cartridge, whereas the invention subject of the present application refers to a permanent housing for a replaceable filter cartridge core that includes a special chamber into which a sensor is installed permanently. More particularly, the present invention refers to an internal filter which equipped with a pair of anodes in a way that when enable to test the condition of the internal itself and not only the water that come out from it.

### DESCRIPTION OF THE DRAWINGS

The intention of the drawings attached to the application is not to limit the scope of the invention and its application.

The drawings are intended only to illustrate the invention and they constitute only one of its many possible implementations.

FIG. 1 presents a cross section of the filtration system (1) comprising a filter housing (2), an internal filter (3), an electrical conductivity meter (4), a pair of contact points (44) (45), and a pair of anodes (41) (42).

FIG. 2 presents a cross section of the filtration system (10) including a filter head (70), a container (60) containing an internal filter (30), an electrical conductivity meter (40), a pair of contact points (440) (450), and a pair of anodes (410) (420).

### THE INVENTION

The term “replaceable filter core” refers, in the present patent, to any filter customarily installed in a filter housing, for instance, a mesh filter made of a material such as polypropylene, that is intended to remove suspended solids, sand, rust and coarse dirt from water. The internal filter may also include one or more of the following filters; a mesh filter, a carbon filter, an antibacterial ceramic ball filter, and siliphos crystals.

As is clear from the drawings attached to the application and from the explanation in this application, that the water filtration system (1) comprises a stand-alone filter housing (2) designed to house a replaceable filter core (3). The stand-alone filter housing (2) is also includes an internal chamber (23) designed to contain an electrical conductivity meter (4).

The main objective of the present invention is to provide a water filtration system (1) that comprises a stand-alone filter housing (2) and a replaceable filter core (3) whereby the stand-alone filter housing (2) is equipped with an electrical conductivity meter (4) and the replaceable filter core (3) has a pair of anodes (41) (42) made of electricity conducting materials that are designed to complement and connect to the electrical conductivity meter (4) through a contact.

The filtration system (1), subject of the present invention, comprises, as mentioned, a stand-alone filter housing (2), a replaceable filter core (3), an electrical conductivity meter (4) and a pair of anodes (41) (42) that are integrated permanently into said replaceable filter core (3). The stand-alone filter housing (2) is designed, in general, like standard filter housings and comprises a base (21) into which the replaceable filter core (3) is inserted, a cover (22) that is designed to cover and seal the stand-alone filter housing (2), and an internal chamber (23) that is designed to contain the electrical conductivity meter (3). The replaceable filter core (3) is equipped and permanently integrated, as mentioned, with a pair of anodes (41) (42) that are attached to and/or integrated into and/or adjacent to said replaceable filter core.

Electrical conductivity meters are familiar devices that are used in a variety of fields. In general, an electrical conductivity meter comprises a pair of anodes that are immersed in a water pipe and a processing unit that measures the conductivity of the water between the anodes. The more chemicals and contaminants there are in the water, the lower the resistance of the water, and vice versa. The conductivity level, after taking into account the temperature of the water, is indicative of the amount of chemicals and contaminants present in the water. The problem with such a filtration system is that the electrical conductivity meter does not check the condition of the filter itself, but only that of the water.

The filtration system (1), subject of the present invention, offers a solution to this problem in that the replaceable filter core (3) is equipped and integrated with a pair of anodes (41) (42) that connect the mesh filter to the electrical conductivity meter (4). The two anodes (41) (42) constitute a continuation and completion of the electrical conductivity meter (4) and enable direct determination of the contamination level of the replaceable filter core itself, to which they are attached. The greater the contamination of the replaceable filter core (3), the lower the resistance between the anodes (41) (42), indicating the need to replace or maintain said filter. The electrical conductivity meter (4) is inserted into the internal chamber (23) of the stand-alone filter housing (2) such that the two anodes (41) (42) are in contact with the two contact points (44) (45), respectively, in a manner that renders said anodes a component and part of the electrical conductivity meter (4).

The filtration system (1) may be equipped with an indication means (5) that displays the contamination level of the replaceable filter core (3). When the contamination level exceeds a predefined threshold, the indication means (5) issues a warning indicating that the water is not clean and that the filter core (3) must be replaced, maintained, or cleaned. The indication means (5) may be a sound-based warning device such as a buzzer, indication lights such as LEDs that turn on and off according to the condition of the water and the filter core (3), or any other suitable indication means.

The indication means may indicate that the filter is functioning properly and the water is suitable for drinking, or it may indicate that the filter is contaminated and may soon require replacement, or it may indicate that immediate replacement of filter is needed. The indication means may, for example, include three LED lamps: green, indicating that the filter is clean and has not reached the predefined threshold contamination level, yellow, indicating that the filter is contaminated and may soon require replacement, and red, indicating that the filter must be replaced immediately. The indication means may also indicate the need to replace the filter based on the time that has elapsed since the installation of the filter. Thus, for instance, if the indication means includes three LED lamps, the green LED will be on following installation, the yellow LED may turn on four or five months after installation, and the red LED may turn on six months after the filter was installed. If the filter becomes contaminated prior to that time, according to a predefined threshold, the relevant lamps will turn on even if the predefined time has not yet elapsed.

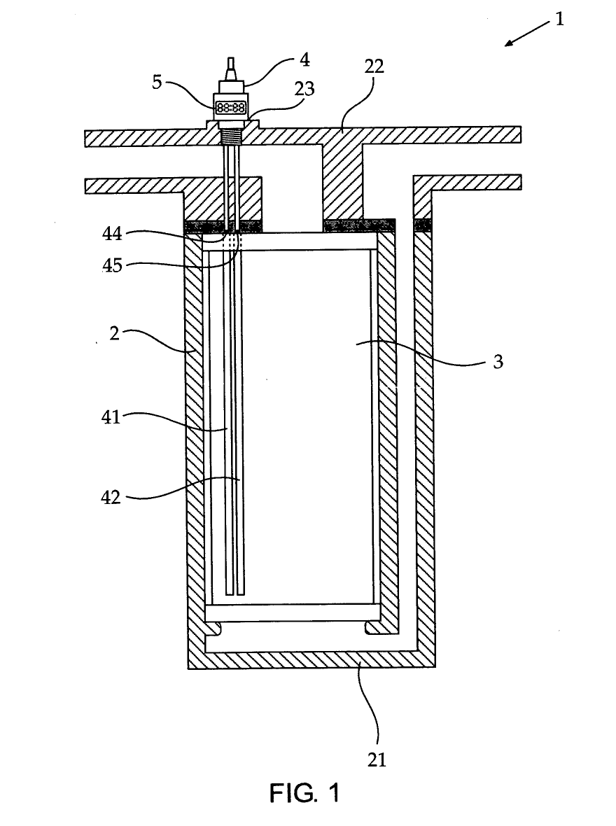

FIG. 1 presents a cross section of the filtration system (1) comprising a stand-alone filter housing (2), a replaceable filter core (3), an electrical conductivity meter (4), a pair of contact points (44) (45), and a pair of anodes (41) (42).

The second implementation of the present application refers to a water filtration system (10) with an internal filter (30) that comprises replaceable integral filter housing (60) that is designed to be inserted into a permanent head (70) of the system such that when the internal filter (30) is replaced, the entire filter housing (60), into which the filter (30) is integrated, is replaced. This kind of filtration system (10) is used, for instance, in refrigerators as well as in systems that are installed near kitchen sink faucets. In the second implementation of the present invention, the electrical conductivity meter (40) is integrated into an internal chamber (230) is located within the permanent system head (70). As mentioned, the internal filter (30) is equipped with a pair of anodes (410) (420) that are in contact with a pair of contact points (440) (450) located in the electrical conductivity meter (40). The two anodes (410) (420) can pass through holes in the filter housing (60) in order to come in contact with said contact points. This implementation of the invention may also include indication means as described above for the first implementation.

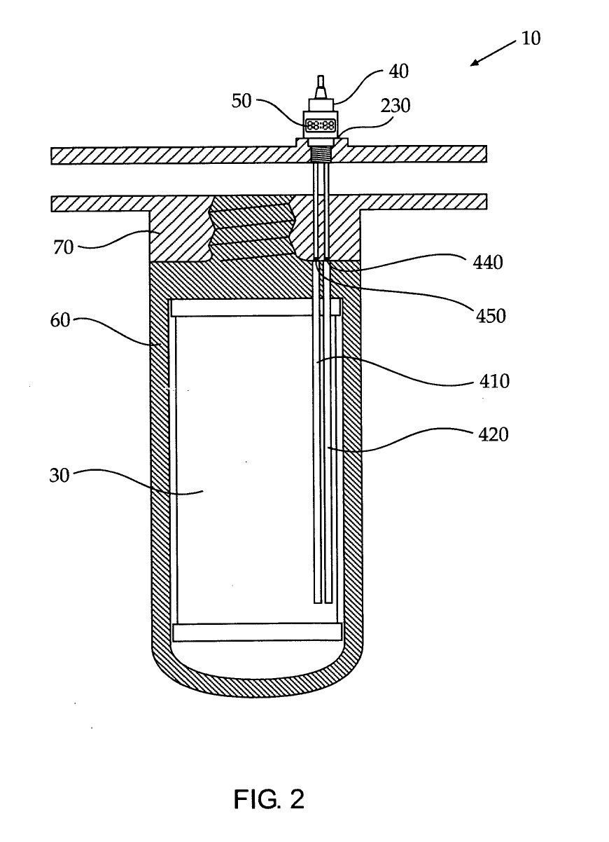

FIG. 2 presents a cross section of the filtration system (10) including a filter head (70), a container (60) containing an internal filter (30), an electrical conductivity meter (40), a pair of contact points (440) (450), and a pair of anodes (410) (420).

The filtration systems (1) (10) can be used in domestic settings, in industrial setting, and in other settings and may be designated for the filtration of a variety of fluids and not only drinking water. In addition, the systems (1) (10) may be equipped with wireless transmitters that transmit the information to remote indication means installed at a distance from such systems. Such transmission may also be cellular, using a cellular card that is installed in the system and transmits the information to a cellular phone or to any other communications device.

What is claimed is:

1. A water filtration system that comprises a stand-alone filter housing a replaceable filter core for water treatment and an electrical conductivity meter; wherein said stand-alone filter housing has an internal chamber that is designed to contains said electrical conductivity meter; wherein said stand-alone filter housing is designed to contain said replaceable filter core wherein said electrical conductivity meter is equipped with a pair of contact points; wherein a pair of anodes are integrated permanently into said replaceable filter core; wherein said pair of anodes are designed to be in contact with said pair of contact points and as a result, with said electrical conductivity meter; whereby said electrical conductivity meter together with said pair of anodes, which are integrated into said replaceable filter core, enable direct determination of a contamination level of said replaceable filter core itself.

2. A water filtration system that comprises a permanent system head and a replaceable internal filter that is integrated in an integral filter housing; wherein said permanent system head has an internal chamber which is designed to contains an electrical conductivity meter; wherein said electrical conductivity meter is equipped with a pair of contact points;
and wherein said internal filter is equipped and integrated with a pair of anodes that are designed to be in contact with said pair of contact points and, as a result, with the electrical conductivity meter; whereby said electrical conductivity meter together with said pair of anodes, which are integrated into said internal filter, enable direct determination of a contamination level of said internal filter itself.

3. A replaceable filter core for water treatment which includes a pair of anodes that are integrated permanently into said replaceable filter core; wherein said replaceable filter core is aimed to be installed in a stand-alone filter housing of a water filtration system; wherein said water filtration system includes an electrical conductivity meter having a pair of contact points; wherein said pair of anodes are designed to be in contact with said pair of contact points; whereby said electrical conductivity meter together with said pair of anodes, which are integrated into said replaceable filter core, enable direct determination of a contamination level of said replaceable filter core itself.

4. An internal filter that is integrated inside a replaceable integral filter housing wherein said internal filter is equipped and integrated with a pair of anodes; wherein said permanent system head includes an electrical conductivity meter having a pair of contact points; wherein said pair of anodes are designed to be in contact with said pair of contact points; whereby said electrical conductivity meter together with said pair of anodes, which are integrated into said internal filter, enable direct determination of a contamination level of said internal filter itself.
